(19) United States
(12) Patent Application Publication
(10) Pub. No.: US 2022/0389198 A1
(43) Pub. Date: Dec. 8, 2022

(54) RUBBER COMPOSITION FOR RUBBER MEMBER DISPOSED BETWEEN INNER LINER AND CARCASS PLY OF PNEUMATIC TIRE, AND PNEUMATIC TIRE

(71) Applicant: TOYO TIRE CORPORATION, Itami-Shi (JP)

(72) Inventor: Shinya Hasegawa, Itami-shi (JP)

(73) Assignee: TOYO TIRE CORPORATION, Itami-Shi (JP)

(21) Appl. No.: 17/739,582

(22) Filed: May 9, 2022

(30) Foreign Application Priority Data
May 25, 2021 (JP) 2021-087847

(51) Int. Cl. C08L 7/00; C08L 9/06; B60C 1/00

(52) U.S. Cl. CPC C08L 7/00; C08L 9/06; B60C 1/00

(57) ABSTRACT

To provide a rubber composition that suppresses shrinkage after molding of a rubber member disposed between an inner liner and a carcass ply of a pneumatic tire, thereby suppressing peeling between members in a green tire and obtaining a green tire having a stable shape, and a pneumatic tire using the rubber composition. Disclosed is a rubber composition for use in a rubber member disposed between an inner liner and a carcass ply of a pneumatic tire, the composition containing a diene-based rubber and a pyrolytic carbon black.

### BACKGROUND OF THE INVENTION

### 1. Field of the Invention

The present invention relates to a rubber composition for a rubber member disposed between an inner liner and a carcass ply of a pneumatic tire, and a pneumatic tire.

### 2. Description of Related Art

A pneumatic tire is composed of a plurality of rubber members. In a green tire before vulcanization, when the rubber member shrinks after molding, there is a concern that defects such as peeling between members or unstable shape of the green tire may occur.

A rubber member may be disposed between the inner liner and the carcass ply for the purpose of enhancing adhesiveness, and particularly, the rubber member is required to be less likely to shrink after molding.

In view of the above points, an object of the present invention is to provide a rubber composition that suppresses shrinkage after molding of a rubber member disposed between an inner liner and a carcass ply of a pneumatic tire, thereby suppressing peeling between members in a green tire and obtaining a green tire having a stable shape, and a pneumatic tire using the rubber composition.

JP-T-2020-523456 (the term “JP-T” as used herein means a published Japanese translation of a PCT patent application) describes a rubber composition containing a surface-treated pyrolytic carbon black, JP-T-2017-524065 describes a rubber composition containing a pyrolytic carbon black coated with a silica layer, and JP-A-2015-131640 describes a rubber composition containing a pyrolytic carbon black as an antistatic agent.

However, none of these documents describes that a green tire that can suppress peeling between members in the green tire and has a stable shape can be obtained by disposing a rubber member made of a rubber composition containing a pyrolytic carbon black between an inner liner and a carcass ply of a pneumatic tire.

### SUMMARY OF THE INVENTION

In order to solve the above-mentioned problem, a rubber composition according to one embodiment of the present invention contains a diene rubber and a pyrolytic carbon black as an inorganic filler, and is disposed between an inner liner and a carcass ply of a pneumatic tire.

The pyrolytic carbon black may contain an ash content of 10 to 25% by mass.

The content of the pyrolytic carbon black may be 10 to 50% by mass of the total inorganic filler.

The pneumatic tire according to an embodiment of the present invention includes the rubber composition disposed between an inner liner and a carcass ply. Advantageous Effects of Invention

According to the rubber composition of the present invention, by suppressing shrinkage of the rubber member after molding, peeling between members in the green tire is suppressed, and a green tire having a stable shape is obtained.

### DESCRIPTION OF EMBODIMENTS

Hereinafter, matters related to the implementation of the present invention will be described in detail.

The rubber composition according to the present embodiment contains a diene-based rubber and a pyrolytic carbon black as an inorganic filler.

The diene-based rubber according to the present embodiment is not particularly limited, and examples thereof include natural rubber (NR), isoprene rubber (IR), butadiene rubber (BR), styrene-butadiene rubber (SBR), styrene-isoprene copolymer rubber, butadiene-isoprene copolymer rubber, and styrene-isoprene-butadiene copolymer rubber. These diene-based rubbers may be used alone or as a blend of two or more thereof. Among these, natural rubber alone or a combination of natural rubber and styrene-butadiene rubber is preferable.

The pyrolytic carbon black according to the present embodiment can be obtained by a pyrolysis process of a used pneumatic tire. The pyrolytic carbon black contains ash, and the content thereof is preferably 10 to 25% by mass. The ash content shall be a value measured in accordance with JIS K6220-1 at a measuring temperature of 750° C. The pyrolytic carbon black is preferably not subjected to a surface treatment.

The specific surface area of the pyrolytic carbon black is not particularly limited, but is preferably 60 to 100 m²/g and preferably 70 to 90 m²/g in terms of N2SA specific surface area. The N2SA specific surface area shall be a value measured in accordance with the multipoint method of JIS K6217.

The rubber composition according to the present embodiment can suppress the shrinkage of a rubber member after molding by containing a pyrolytic carbon black. By disposing this rubber member between an inner liner and a carcass ply, peeling between members in a green tire can be suppressed, and a green tire having a stable shape can be obtained.

In the rubber composition according to the present embodiment, a reinforcing filler such as silica or carbon black not treated by a pyrolysis process (hereinafter simply referred to as carbon black) can be used as an inorganic filler in addition to the pyrolytic carbon black. That is, the inorganic filler may be a combination of carbon black and pyrolytic carbon black, a combination of silica and pyrolytic carbon black, or a combination of carbon black, pyrolytic carbon black, and silica. Preferably, it is a combination of carbon black and pyrolytic carbon black.

The content of the inorganic filler is not particularly limited, and is, for example, preferably 10 to 70 parts by mass, more preferably 20 to 70 parts by mass, and still more preferably 30 to 65 parts by mass with respect to 100 parts by mass of the rubber component.

The content of the pyrolytic carbon black is preferably 10 to 50% by mass of the total inorganic filler. When the content ratio of the pyrolytic carbon black is within the above range, the shrinkage of the rubber member after molding is easily suppressed.

The carbon black (excluding pyrolytic carbon black) is not particularly limited, and various kinds of known carbon black can be used. The content of the carbon black is preferably 5 to 63 parts by mass, more preferably 10 to 63 parts by mass, and still more preferably 15 to 58.5 parts by mass with respect to 100 parts by mass of the rubber component.

The silica is not particularly limited, but wet silica such as wet precipitated silica and wet gel method silica is preferably used. Even when silica is contained, the content of silica is preferably 30 parts by mass or less, more preferably 20 parts by mass or less, and still more preferably 10 parts by mass or less with respect to 100 parts by mass of the rubber component.

The rubber composition according to the present embodiment may further contain a silane coupling agent such as sulfide silane or mercaptosilane. Even when a silane coupling agent is contained, the content of the silane coupling agent is preferably 15 parts by mass or less with respect to 100 parts by mass of silica.

In the rubber composition according to the present embodiment, in addition to the above-described components, compounding chemicals such as process oil, zinc oxide, stearic acid, softening agent, plasticizer, wax, aging inhibitor, vulcanizing agent, and vulcanization accelerator used in the ordinary rubber industry may be appropriately compounded within the ordinary range.

Examples of the vulcanizing agent include sulfur components such as powdered sulfur, precipitated sulfur, colloidal sulfur, insoluble sulfur, and highly dispersible sulfur. The content of the vulcanizing agent is preferably 0.1 to 10 parts by mass, and more preferably 0.5 to 5 parts by mass with respect to 100 parts by mass of the rubber component. The content of the vulcanization accelerator is preferably 0.1 to 7 parts by mass, and more preferably 0.5 to 5 parts by mass with respect to 100 parts by mass of the rubber component.

The rubber composition according to the present embodiment can be produced by kneading in accordance with an ordinary method using a mixer such as a Banbury mixer, a kneader, or a roll that is usually used. That is, it is possible to prepare a rubber composition by adding and mixing other additives excluding a vulcanizing agent and a vulcanization accelerator to the rubber component in the first mixing stage, and adding and mixing the vulcanizing agent and the vulcanization accelerator to the resulting mixture in the final mixing stage.

The rubber composition thus obtained can be applied between a carcass ply and an inner liner of a pneumatic tire for various applications and sizes, such as a large tire for a passenger car, a truck or a bus. For example, a pneumatic tire can be produced by molding a rubber composition into a predetermined shape by extrusion processing, combining the molded rubber composition with other components to produce a green tire, and then performing vulcanization molding at, for example, 130 to 190° C.

The type of the pneumatic tire according to the present embodiment is not particularly limited, and as described above, various tires such as a tire for a passenger car and a tire for a heavy load used for a truck, a bus, or the like are exemplified.

### EXAMPLES

Examples of the present invention will be described below, but the present invention is not limited to these examples.

Using a Banbury mixer, according to the mix proportion (parts by mass) shown in Table 1 below, components other than a vulcanization accelerator and sulfur were added and mixed (discharge temperature=160° C.) in the first mixing stage (non-processing kneading process), and a vulcanization accelerator and sulfur were added and mixed (discharge temperature=90° C.) in the final mixing stage (processing kneading process) to prepare a rubber composition.

The details of each component in Table 1 are as follows.
Natural rubber: RSS #3
SBR: “JSR1502” manufactured by JSR Corporation
Carbon Black: “SEAST V” manufactured by Tokai Carbon Co., Ltd., ash content=0.1% by mass, N₂SA specific surface area =27 m²/g
Pyrolytic carbon black 1: ash content=15.1% by mass, N2SA specific surface area=87 m²/g
Pyrolytic carbon black 2: ash content =20.8% by mass, N2SA specific surface area=75 m²/g
Zinc oxide: “Zinc Oxide Type III” manufactured by Mitsui Mining & Smelting Co., Ltd.
Stearic acid: “Bead Stearic Acid” manufactured by NOF Corporation
Aging inhibitor: “NOCRAC 6C” manufactured by Ouchi Shinko Chemical Industrial Co., Ltd.
Oil: “Process NC140” manufactured by ENEOS Corporation
Sulfur: “Powdered sulfur” manufactured by Tsurumi Chemical Industry Co., Ltd.
Vulcanization accelerator: “Sanceler NS-G” manufactured by Sanshin Chemical Industry Co., Ltd.

The ash content in the pyrolytic carbon black was measured in accordance with JIS K6220-1 at a measuring temperature of 750° C.

The N2SA specific surface area of the pyrolytic carbon black was measured in accordance with the multipoint method of JIS K6217.

With respect to each of the rubber compositions obtained, the shrinkage property of the rubber was evaluated. The evaluation method is as follows.
Rubber shrinkage 1 (grain direction): The obtained rubber composition was extruded using a roll whose temperature was adjusted to 80° C., and then the length in the grain direction of the sample immediately after extrusion was measured. Thereafter, the sample was allowed to stand at room temperature for 24 hours, the length in the grain direction of the sample after allowing to stand for 24 hours was measured, and the degree of shrinkage was obtained based on the following formula. A degree of shrinkage closer to 0% indicates that the sample has not shrunk. Note that the grain direction refers to an extrusion direction in which the rubber composition is extruded using a roll.

Degree of shrinkage={(length immediately after extrusion—length after standing for 24 hours)/length immediately after extrusion}×100
Rubber shrinkage 2 (against-the-grain direction): The degree of shrinkage was determined in the same manner as described above except that the length of the sample in the against-the-grain direction was measured. As the degree of shrinkage is closer to 0%, there is no elongation in the against-the-grain direction, indicating that the sample has not shrunk. Note that the against-the-grain direction refers to a direction orthogonal to the extrusion direction in which the rubber composition is extruded using a roll.

TABLE 1

| | Comparative | Example | Example | Example |
|---|---|---|---|---|
| | Example 1 | 1 | 2 | 3 |
| Natural rubber | 50 | 50 | 50 | 50 |
| SBR | 50 | 50 | 50 | 50 |
| Carbon black | 60 | 52 | 45 | 30 |
| Pyrolytic carbon | — | 8 | 15 | — |
| black 1 | | | | |
| Pyrolytic carbon | — | — | — | 30 |
| black 2 | | | | |
| Zinc oxide | 3 | 3 | 3 | 3 |
| Stearic acid | 1 | 1 | 1 | 1 |
| Aging inhibitor | 1 | 1 | 1 | 1 |
| Oil | 10 | 10 | 10 | 10 |
| Sulfur | 2 | 2 | 2 | 2 |
| Vulcanization | 1 | 1 | 1 | 1 |
| accelerator | | | | |
| Rubber shrinkage 1 | 24 | 21 | 19 | 17 |
| (grain direction) | | | | |
| Rubber shrinkage 2 | −10 | −7 | −6 | −5 |
| (against-the-grain | | | | |
| direction) | | | | |

The results are as shown in Table 1, and it can be seen from the comparison between Comparative Example 1 and Examples 1 to 3 that shrinkage in the grain direction and elongation in the against-the-grain direction could be suppressed in the case of containing pyrolytic carbon black. Industrial Applicability

The rubber composition of the present invention can be used for various tires such as passenger cars, light trucks, and buses.

What is claimed is:

1. A rubber composition for use in a rubber member disposed between an inner liner and a carcass ply of a pneumatic tire, the composition comprising a diene-based rubber and a pyrolytic carbon black as an inorganic filler.

2. The rubber composition according to claim 1, wherein the pyrolytic carbon black contains an ash content of 10 to 25% by mass.

3. The rubber composition according to claim 1, wherein the content of the pyrolytic carbon black is 10 to 50% by mass of the total inorganic filler.

4. The rubber composition according to claim 2, wherein the content of the pyrolytic carbon black is 10 to 50% by mass of the total inorganic filler.

5. A pneumatic tire comprising the rubber composition according to claim 1 disposed between an inner liner and a carcass ply.

6. A pneumatic tire comprising the rubber composition according to claim 2 disposed between an inner liner and a carcass ply.

7. A pneumatic tire comprising the rubber composition according to claim 3 disposed between an inner liner and a carcass ply.

8. A pneumatic tire comprising the rubber composition according to claim 4 disposed between an inner liner and a carcass ply.
